(19) United States
(12) Patent Application Publication
(10) Pub. No.: US 2021/0090115 A1
(43) Pub. Date: Mar. 25, 2021

(54) INFORMATION PROCESSING DEVICE AND METHOD

(71) Applicant: TOSHIBA TEC KABUSHIKI KAISHA, Tokyo (JP)

(72) Inventor: Takeshi Maeda, Izunokuni Shizuoka (JP)

(21) Appl. No.: 16/924,234

(22) Filed: Jul. 9, 2020

(30) Foreign Application Priority Data
Sep. 24, 2019 (JP) 2019-173498

(51) Int. Cl. G06Q 30/02; G06F 16/23; G06F 16/955; G06Q 20/20

(52) U.S. Cl. CPC G06Q 30/0238; G06F 16/23; G06F 16/955; G06Q 20/202; G06Q 20/203; G06Q 30/0226; G06Q 20/201

(57) ABSTRACT

According to one embodiment, an information processing device includes an identification information reception unit configured to receive identification information for specifying a transaction target; an extraction unit configured to refer to privilege related information obtained by correlating the identification information with privilege information about the transaction target specified with the identification information and extract the privilege information about the transaction target specified with the identification information received by the identification information reception unit; and an output unit configured to output the privilege information extracted by the extraction unit.

### CROSS-REFERENCE TO RELATED APPLICATION

This application is based upon and claims the benefit of priority from Japanese Patent Application No. 2019-173498, filed in Sep. 24, 2019, the entire contents of which are incorporated herein by reference.

### FIELD

Embodiments described herein relate to an information processing device and a method.

### BACKGROUND

When a customer purchases a transaction target such as a merchandise or a service, the customer may receive a privilege such as price reduction or additional points to be granted. Generally, the customer can obtain information about a privilege (privilege information) from commercials or the like and do the shopping to receive the privilege. For example, a company operating a store posts a coupon on a website of the company so that the store provides the privilege information. Therefore, the customer can access the website, download the coupon into a mobile terminal, and presents the obtained coupon during the payment, to receive the price reduction. The store provides the privilege information by distributing a flyer on which special sale information is posted, and the customer may look at the special sale information described on the flyer and buy a special sale item, to receive a privilege. Examples of these privileges include various privileges such as those given to a number of unspecified customers or those given only to members of the store.

As described above, in the related art, the store unilaterally provides the privilege information to the customer and it is not considered that the provision of the privilege information can respond to individual customer requests. For example, during the shopping in a supermarket, even if a customer desires to know privilege information about a merchandise that the customer considers to purchase on the spot, the customer cannot know the privilege information except for a limited merchandise about which privilege information is promoted at the store.

### DESCRIPTION OF THE DRAWINGS

FIG. 1 is a schematic diagram illustrating a system including an information processing device of an embodiment;

FIG. 2 is a block diagram illustrating a hardware configuration of the information processing device;

FIG. 3 is a diagram illustrating a content of a merchandise master unit of a memory unit in the information processing device;

FIG. 4 is a diagram illustrating a content of a member master unit of the memory unit;

FIG. 5 is a diagram illustrating a content of a coupon master unit of the memory unit;

FIG. 6 is a block diagram illustrating a functional configuration of the information processing device;

FIG. 7 is a block diagram illustrating a hardware configuration of a customer terminal;

FIG. 8 is a functional block diagram illustrating a function of the customer terminal;

FIG. 9 is a flowchart for describing a process of a control unit of the information processing device;

FIG. 10 is a flowchart for describing a process of a control unit of the customer terminal;

FIG. 11 is a diagram illustrating an operation screen on the customer terminal during scanning;

FIG. 12 is a diagram illustrating a display screen of privilege information on the customer terminal; and

FIG. 13 is a diagram illustrating a display screen of other privilege information on the customer terminal.

### DETAILED DESCRIPTION

Exemplary embodiments provide an information processing device configured to provide privilege information about a transaction target when the transaction target such as a merchandise or a service is desired to be purchased, and a method thereof.

In general, according to one embodiment, an information processing device includes an identification information reception unit configured to receive identification information for specifying a transaction target; an extraction unit configured to refer to privilege related information obtained by correlating the identification information with privilege information about the transaction target specified with the identification information and extract the privilege information about the transaction target specified with the identification information received by the identification information reception unit; and an output unit configured to output the privilege information extracted by the extraction unit.

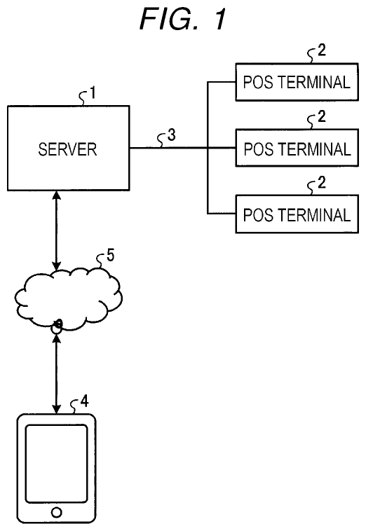

Hereinafter, an information processing device of the embodiment with reference to the drawings. FIG. 1 is a diagram illustrating schematically a system including a server 1 which is the information processing device. The server 1 is connected to a plurality of point of sales (POS) terminals 2 disposed in a store via a network such as a local area network (LAN) 3. In the present embodiment, the server 1 is described as a server disposed in each store, but may be a server provided in a headquarters that collects information on a plurality of stores. The server 1 is connected to a customer terminal 4 configured with a smartphone and the like via a network 5 which is a public network such as the Internet. The customer terminal 4 stores a program for transmitting and receiving information to and from the server 1. This program is stored in a computer connected to a network such as the Internet by a company operating a store and is downloaded by a customer via a network to be obtained by the customer.

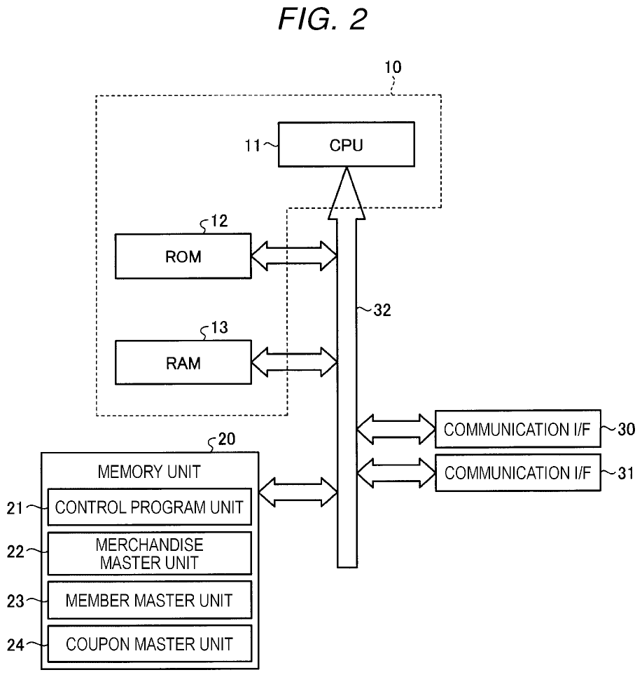

Subsequently, based on FIG. 2, a hardware configuration of the server 1 is described. The server 1 includes a control unit 10, a memory unit 20, and communication interfaces (I/F) 30 and 31. The control unit 10, the memory unit 20, and the communication I/Fs 30 and 31 are connected to each other via a bus 32.

The control unit 10 includes a central processing unit (CPU) 11, a read only memory (ROM) 12, and a random access memory (RAM) 13. The CPU 11, the ROM 12, and the RAM 13 are connected to each other via the bus 32. The CPU 11 is a control entity of the control unit 10. The ROM 12 stores various programs. Various programs and various kinds of data that are stored in the ROM 12 or the memory unit 20 are loaded into the RAM 13. The control unit 10 executes various control processes of the server 1 by an operation of the CPU 11 according to a control program that is stored in the ROM 12 or the memory unit 20 and is loaded into the RAM 13.

The memory unit 20 includes a control program unit 21, a merchandise master unit 22, a member master unit 23, and a coupon master unit 24. The control program unit 21 is an area for storing various control programs. The merchandise master unit 22 configures a privilege information storage unit and a merchandise information storage unit and stores a merchandise master. The member master unit 23 configures a member privilege information storage unit together with the coupon master unit 24 and stores a member master. The coupon master unit 24 stores a coupon master. Details of each master are described below.

The communication I/F 30 is connected to the POS terminal 2 via the LAN 3. The communication I/F 31 is connected to the customer terminal 4 via the network 5. Accordingly, the control unit 10 can transmit and receive information to and from the POS terminal 2 or the customer terminal 4.

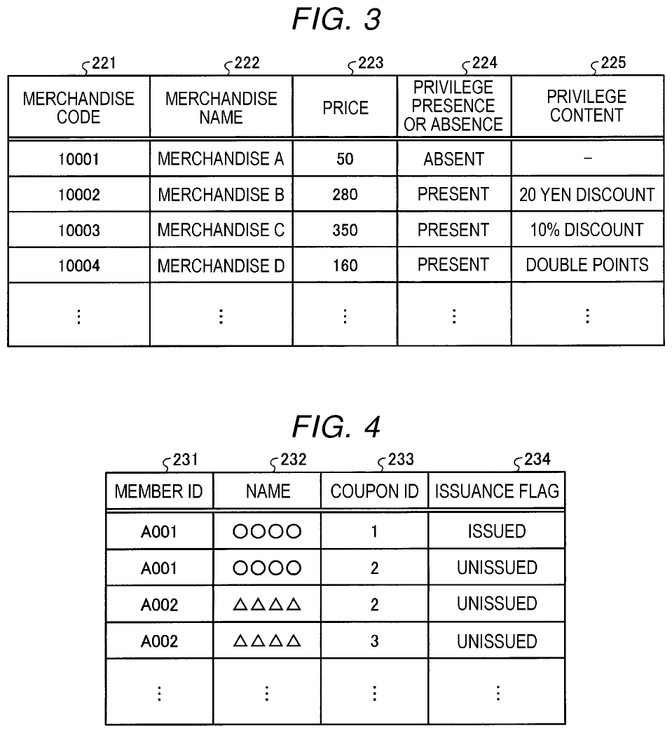

FIG. 3 is a diagram illustrating a content of the merchandise master. The merchandise master stores privilege related information obtained by correlating identification information with privilege information about a transaction target specified with the identification information. Specifically, the merchandise master stores a merchandise name 222, a price 223, privilege presence or absence 224, and a privilege content 225 in correlation with a merchandise code 221. The merchandise code 221 is identification information for specifying a merchandise which is a transaction target. The merchandise name 222 indicates a name of a merchandise. The price 223 is a selling price of a merchandise decided by the store. The privilege presence or absence 224 is information indicating whether there is a privilege on the merchandise. The privilege content 225 indicates a content of the privilege. The privilege presence or absence 224 and the privilege content 225 are privilege information. The privilege is to provide special arrangements for a purchaser of the merchandise, and for example, are price reduction or discount off the price 223 for a limited period of time and additional points to be granted, and the like. However, the privilege is not limited to the examples.

FIG. 4 is a diagram illustrating a content of a member master. The member master is to manage a member customer and stores a name 232, a coupon ID 233, and an issuance flag 234 in correlation with a member ID 231. The member ID 231 is information indicating that the customer is a member. The name 232 is the name of the member. The coupon ID 233 is information indicating a privilege to be received by the member. In the example indicated by the drawings, a member A001 can receive privileges of coupon IDs 1 and 2, and a member A002 can receive privileges of coupon IDs 2 and 3. However, the privilege to be received by the member may be common to all members. The issuance flag 234 stores whether the member already receives a privilege. The example of the drawing illustrates that the member A001 already receives the privilege of the coupon ID 1 and can receive only the privilege of the coupon ID 2 at this moment.

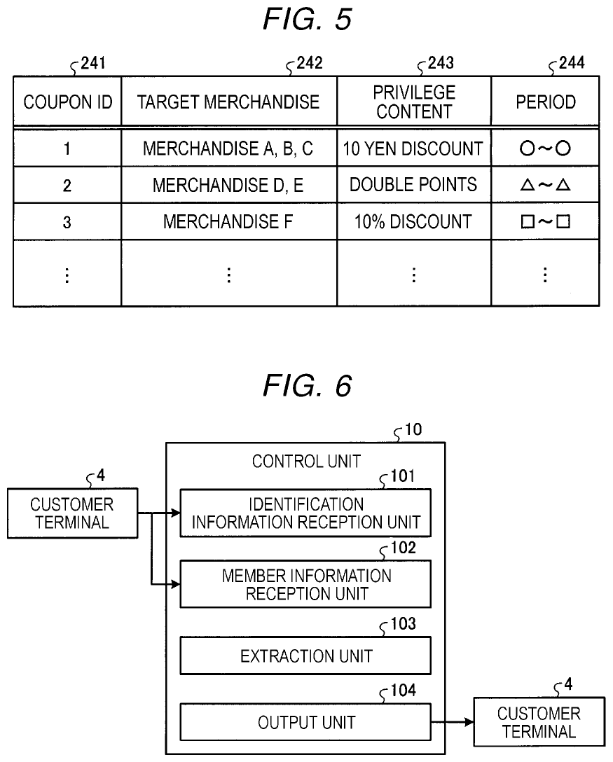

FIG. 5 is a diagram illustrating a content of the coupon master. The coupon master stores a target merchandise 242, a privilege content 243, a period 244 in correlation with a coupon ID 241. The coupon ID 241 is information which is the same as the coupon ID 233 stored in the member master. The target merchandise 242 is a merchandise that becomes a target of the privilege specified with the coupon ID. The privilege content 243 is a content of the privilege specified with the coupon ID. The period 244 is a period to which the privilege specified with the coupon ID is applied. The content of the member master and the content of the coupon master configure the member privilege information. That is, if a member ID is specified, the server 1 can specify a privilege that can be received by the member specified with the member ID by referring to member privilege information configured with the member master illustrated in FIG. 4 and the coupon master illustrated in FIG. 5.

Subsequently, the functional configuration of the control unit 10 is described with reference to FIG. 6. The control unit 10 functions as an identification information reception unit 101, a member information reception unit 102, an extraction unit 103, and an output unit 104 by an operation of the CPU 11 according to the control program stored in the ROM 12 or the memory unit 20.

The identification information reception unit 101 receives the identification information for specifying a transaction target from the customer terminal 4. Specifically, the identification information reception unit 101 receives the merchandise code read by the customer terminal 4. The member information reception unit 102 receives the member information indicating that the customer is a member from the customer terminal 4. Specifically, the member information reception unit 102 receives the member ID input to the customer terminal 4.

The extraction unit 103 refers to the privilege information storage unit for a transaction target specified with the identification information received by the identification information reception unit 101 and extracts the privilege information. Specifically, the extraction unit 103 refers to the merchandise master unit 22 for the merchandise specified with the merchandise code received by the identification information reception unit 101 and extracts the privilege presence or absence and the privilege content of the merchandise. The output unit 104 outputs the privilege information extracted by the extraction unit 103. Specifically, the output unit 104 outputs the privilege presence or absence and the privilege content extracted by the extraction unit 103 to the customer terminal 4.

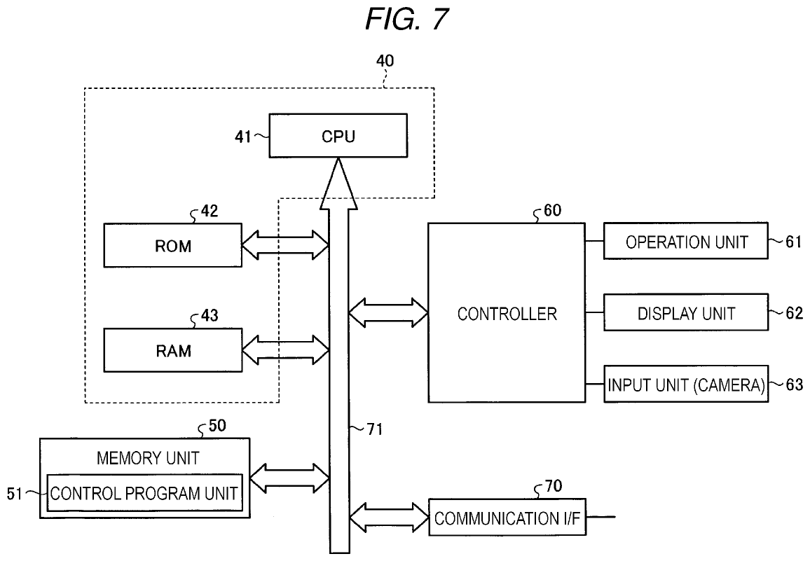

Subsequently, based on FIG. 7, the hardware configuration of the customer terminal 4 is described. The customer terminal 4 is, for example, an information terminal such as a smartphone and includes a control unit 40, a memory unit 50, a controller 60, an operation unit 61, a display unit 62, a camera 63 which is an input unit, a communication interface (I/F) 70, and the like. The control unit 40, the memory unit 50, the controller 60, and the communication I/F 70 are connected to each other via the bus 71.

The control unit 40 includes a central processing unit (CPU) 41, a read only memory (ROM) 42, and a random access memory (RAM) 43. The CPU 41, the ROM 42, and the RAM 43 are connected to each other via the bus 71. The CPU 41 is a control entity of the control unit 40. The ROM 42 stores various programs. Various programs and various kinds of data stored in the ROM 42 or the memory unit 50 are loaded into the RAM 43. The control unit 40 executes various control processes of the customer terminal 4 by an operation of the CPU 41 according to a control program that is stored in the ROM 42 or the memory unit 50 and loaded into RAM 43.

The memory unit 50 includes a control program unit 51 which is an area that stores various control programs. The controller 60 is connected to the operation unit 61, the display unit 62, and the camera 63. The operation unit 61 instructs the customer terminal 4 to perform various operations. The display unit 62 performs various displays to the user and displays, for example, information received from the server 1. The camera 63 functions as an input unit that inputs a merchandise code. A merchandise code is input by reading a barcode attached to the merchandise by the camera 63. The communication I/F 70 is connected to the server 1 via the network 5.

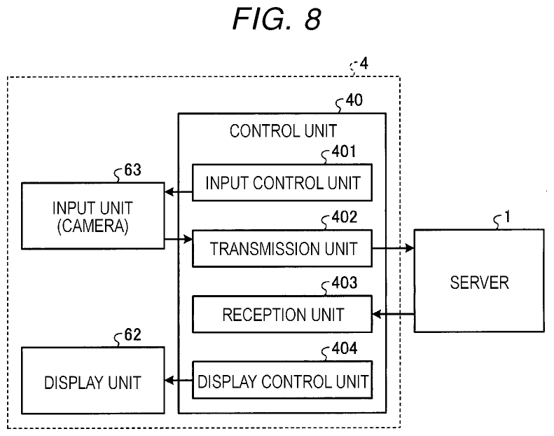

Subsequently, the functional configuration of the control unit 40 of the customer terminal 4 is described with reference to FIG. 8. The control unit 40 functions as an input control unit 401, a transmission unit 402, a reception unit 403, and a display control unit 404 by an operation of the CPU 11 according to the control program stored in the ROM 12 or the memory unit 20.

The input control unit 401 controls the camera 63 so that the camera 63 reads the barcode attached to the merchandise. The transmission unit 402 analyzes the barcode read by the camera 63, recognizes the merchandise code, and also transmits the merchandise code to the server 1. The transmission unit 402 has a function of asking the server 1 about the privilege information about the merchandise specified with the merchandise code. The reception unit 403 receives the privilege information of the merchandise specified with the merchandise code transmitted by the transmission unit 402 from the server 1. The display control unit 404 controls the display unit 62 and displays the privilege information received by the reception unit 403 to the display unit 62.

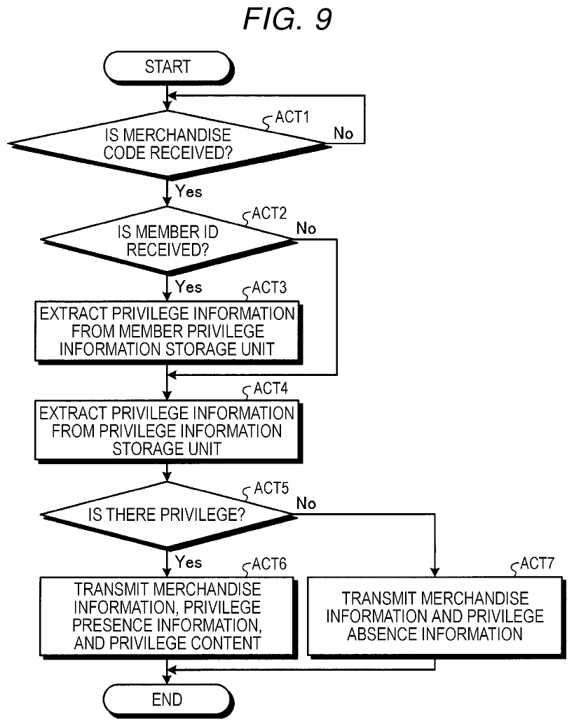

Subsequently, referring to a flowchart of FIG. 9, a process performed by the control unit 10 of the server 1 is described. The control unit 10 determines whether the identification information reception unit 101 receives the merchandise code which is the identification information from the customer terminal 4 (ACT 1). When the identification information reception unit 101 receives the identification information, the control unit 10 determines whether the member information reception unit 102 receives the member ID which is the member information (ACT 2). When the identification information reception unit 101 does not receive the identification information, the control unit 10 returns to ACT 1 and stands by. In ACT 2, when the member information reception unit 102 receives the member ID, the extraction unit 103 refers to the member master unit 23 and the coupon master unit 24 and extracts the privilege information from the member privilege information storage unit. The extraction is performed as follows.

First, the extraction unit 103 refers to the member master unit 23 illustrated in FIG. 4 and specifies an unissued coupon among the coupon IDs 233 correlating with the member ID 231 received by the member information reception unit 102. Whether the coupon ID 233 is already issued is determined based on the issuance flag 234. Subsequently, the extraction unit 103 refers to the coupon master unit 24 illustrated in FIG. 5 and first determines whether the privilege specified with the specified coupon ID is within the target period. When the privilege is within the target period, the extraction unit 103 determines whether there is a merchandise specified with the merchandise code received in ACT 1 among the target merchandises 242 stored in correlation with the coupon ID. When the merchandise specified with the received merchandise code is included in the target merchandise 242, the extraction unit 103 extracts the privilege content stored in correlation with the coupon ID as the privilege information. When the merchandise specified with the received merchandise code is not included in the target merchandise 242, the extraction unit 103 extracts information that there is no privilege relating to the merchandise as the privilege information. In this manner, a process of extracting the privilege information from the member privilege information storage unit is performed.

Referring back to FIG. 9, in ACT 2, when the member information reception unit 102 does not receive the member ID for a predetermined period of time from when the identification information reception unit 101 receives the identification information in ACT 1, the control unit 10 skips ACT 3. Subsequently, the extraction unit 103 refers to the merchandise master and extracts the privilege information from the privilege information storage unit (ACT 4). Specifically, the extraction unit 103 extracts the privilege presence or absence 224 and the privilege content 225 corresponding the merchandise code received by the identification information reception unit 101 as the privilege information.

Subsequently, the control unit 10 determines whether the privilege information extracted in ACTs 3 and 4 is information that there is a privilege (ACT 5). In case of the information that there is a privilege, the output unit 104 transmits the privilege information such as the information indicating that there is a privilege and the content of the privilege in addition to the merchandise name to the customer terminal 4 (ACT 6) and ends the process. In ACT 5, in case of the information that there is no privilege, the output unit 104 transmits the information indicating that there is no privilege in addition to the merchandise name, as the privilege information, to the customer terminal 4 (ACT 7) and ends the process.

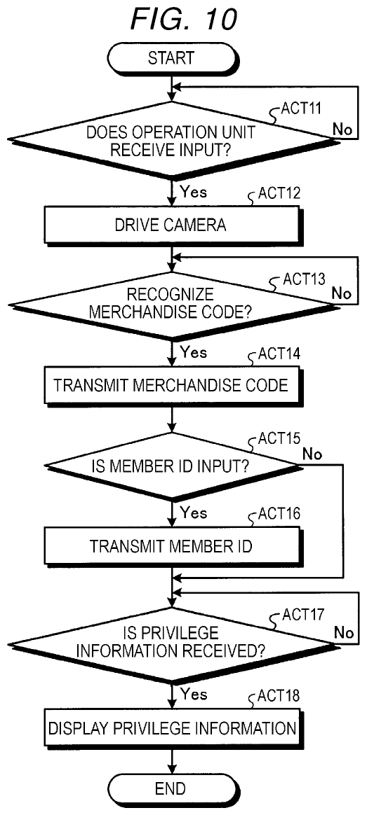

FIG. 10 is a flowchart indicating a process of the control unit 40 of the customer terminal 4. This process is performed, for example, when the customer desires to obtain the privilege information of the merchandise during the shopping. The control unit 40 determines whether the operation unit 61 receives an input for driving a program to obtain the privilege information of the merchandise (ACT 11). When the input is received, the input control unit 401 drives the camera 63 (ACT 12). When the input is not received, the control unit 40 returns to ACT 11 and stands by.

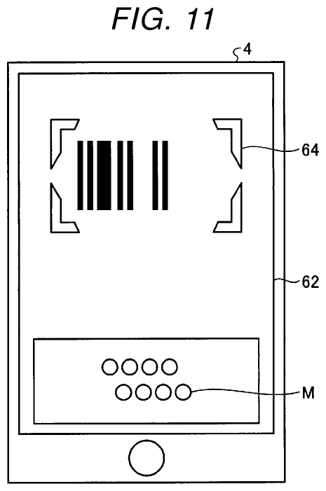

An example of the display by the display unit 62 when the camera 63 is driven in ACT 12 is illustrated in FIG. 11. A message OO is presented in a lower portion of the display unit 62. For example, a message such as “Please scan a barcode of a merchandise of which privilege presence or absence is desired to be searched, on a coupon or the like.” is displayed. Meanwhile, a reading unit 64 that reads the barcode attached to the merchandise is formed on an upper portion of the display unit 62. Referring back to FIG. 10, the control unit 40 reads the barcode attached to the merchandise and determines whether the merchandise code which is the identification information is recognized (ACT 13). When the control unit 40 recognizes the merchandise code, the transmission unit 402 transmits the merchandise code to the server 1 (ACT 14). In ACT 13, when the merchandise code is not recognized, the control unit 40 returns to ACT 13 and stands by.

In ACT 14, after the transmission unit 402 transmits the merchandise code, the control unit 40 determines whether an input of the member ID is received (ACT 15). When an input of the member ID is received, the transmission unit 402 transmits a member ID to the server 1 (ACT 16). When an input of the member ID is not received for a predetermined period of time, the control unit 40 skips ACT 16. Subsequently, the control unit 40 determines whether the reception unit 403 receives the privilege information from the server 1 (ACT 17). When the reception unit 403 receives the privilege information, the display control unit 404 controls the display unit 62 and displays the privilege information (ACT 18), and the control unit 40 ends the process. In ACT 17, when the privilege information is not received, the reception unit 403 stands by.

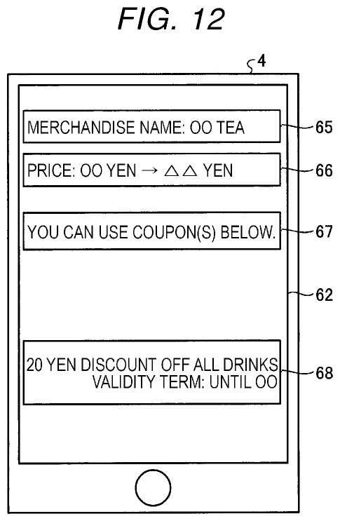

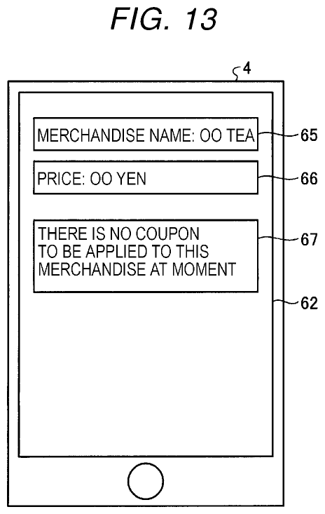

An example of a display of the privilege information by the display unit 62 is illustrated in FIGS. 12 and 13. FIG. 12 is an example of a display of the privilege information when there is a privilege. The display unit 62 displays a privilege presence or absence message 67 and a privilege content 68 which are the privilege information, in addition to a merchandise name 65 and a price 66. In the price 66, a selling price of the store and a price when the privilege is used are presented. The customer can obtain the privilege by promoting the privilege content 68 during the payment. In other words, in this example, the privilege content 68 is information required for the customer who is a user to receive the privilege. FIG. 13 is an example of a display of the privilege information when there is no privilege. The display unit 62 displays the merchandise name 65, the price 66, and the privilege presence or absence message 67 which is the privilege information.

As described above, relating to the merchandise specified with the identification information received from the customer terminal 4, the information processing device of the present embodiment outputs the privilege information thereof to the customer terminal 4. Accordingly, since the privilege information can be displayed to the customer terminal 4, the customer who does the shopping can know whether there is a privilege to a merchandise that the customer considers to purchase on the spot. The customer can know the content of the privilege on the spot. In this manner, the information processing device of the present embodiment can provide the customer with the information for determining whether to purchase the merchandise, and thus the satisfaction of the customer can be increased.

The information processing device of the present embodiment includes the member master unit 23 and the coupon master unit 24 which are the member privilege information storage unit that stores the privilege information for the member, in addition to the merchandise master unit 22 that stores the privilege information of the merchandise. When the information processing device receives the member information in addition to the identification information from the customer terminal 4, the information processing device refers to the member master unit 23 and the coupon master unit 24, extracts the privilege information for the member, and outputs the privilege information to the customer terminal 4. Accordingly, the customer terminal 4 can also display the privilege specific to the member in addition to the privilege relating to the merchandise. Therefore, the information processing device of the present embodiment can provide more satisfactory service for the customer.

The information processing device of the present embodiment outputs the information that is required for the customer who is the user to receive the service, as the privilege information, to the customer terminal 4. Therefore, the customer not only knows the presence or absence of the privilege and the content of the privilege, but also easily performs an operation for receiving the privilege. For example, with respect to the privilege specific to the member or the like, the customer may have to present during the payment that the customer is eligible for the privilege. Therefore, the customer may be required to perform an operation of downloading required information from a website of the store, or the like. However, according to the information processing device of the present embodiment, together with the privilege information, the required information for receiving the privilege is transmitted to the customer terminal 4. Therefore, the customer is no more required to perform an operation for obtaining the required information.

The information processing device of the present embodiment includes the merchandise master unit 22 which is the merchandise information storage unit that stores the merchandise code which is the identification information and the price which is price information of the merchandise specified with the merchandise in a correlating manner. The merchandise code is used when the POS terminal 2 obtains the price information required during the payment process. According to the present embodiment, the merchandise code used during the payment process is also used in the process for obtaining the privilege information, and thus the configuration can be simplified.

According to the present embodiment, the transaction target is described as the merchandise, but may be a service. The privilege information output by the information processing device is set as the presence and absence of the privilege, the content of the privilege, and the information required when the privilege is received, but may be any one of these. The information processing device is described as the server 1, but may be the customer terminal 4.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a memory that stores computer executable components; and
a processor that executes the computer executable components stored in the memory, wherein the computer executable components comprise:
an identification information reception component configured to receive identification information for specifying a transaction target;
an extraction component configured to refer to privilege related information obtained by correlating the identification information with privilege information about the transaction target specified with the identification information and extract the privilege information about the transaction target specified with the identification information received by the identification information reception component; and
an output component configured to output the privilege information extracted by the extraction component.

2. The device according to claim 1, further comprising:
a member information reception component configured to receive member information indicating a member,
wherein the extraction component refers to member privilege information obtained by correlating the member information with privilege information for the member specified with the member information with respect to the transaction target specified with the identification information received by the identification information reception unit and extracts the privilege information for the member received by the member information reception component.

3. The device according to claim 1,
wherein the output component outputs information required by a user for receiving a privilege as the privilege information.

4. The device according to claim 1, further comprising:
a merchandise information storage component configured to store the identification information and price information of the transaction target specified with the identification information in a correlating manner.

5. The device according to claim 1,
wherein the identification information comprises a merchandise code.

6. The device according to claim 1,
wherein the privilege information comprises a coupon for a price reduction of the transaction target.

7. The device according to claim 1,
wherein the privilege information comprises a gift of additional reward points for purchasing the transaction target.

8. A method of controlling an information processing device by a computer,
receiving, by the computer, identification information for specifying a transaction target;
referring to privilege related information obtained by correlating the identification information with privilege information about the transaction target specified with the identification information and extracting the privilege information about the transaction target specified with the identification information received; and
outputting the privilege information extracted.

9. The method according to claim 8, further comprising:
a member information reception component configured to receiving member information indicating a member; and
referring to member privilege information obtained by correlating the member information with privilege information for the member specified with the member information with respect to the transaction target specified with the identification information received by the identification information reception unit and extracting the privilege information for the member received.

10. The method according to claim 8, further comprising:
outputting information required by a user for receiving a privilege as the privilege information.

11. The method according to claim 8, further comprising:
storing the identification information and price information of the transaction target specified with the identification information in a correlating manner.

12. The method according to claim 8,
wherein the identification information comprises a merchandise code.

13. The method according to claim 8,
wherein the privilege information comprises a coupon for a price reduction of the transaction target.

14. The method according to claim 8,
wherein the privilege information comprises a gift of additional reward points for purchasing the transaction target.

15. A non-transitory computer program product for managing information, the non-transitory computer program product comprising a computer readable storage medium having program instructions embodied therewith, the program instructions executable by a processing component to cause the processing component to:
receiving identification information for specifying a transaction target;
referring to privilege related information obtained by correlating the identification information with privilege information about the transaction target specified with the identification information and extract the privilege information about the transaction target specified with the identification information received; and
outputting the privilege information extracted.

16. The non-transitory computer program product according to claim 15, further comprising:
a member information reception component configured to receiving member information indicating a member; and
referring to member privilege information obtained by correlating the member information with privilege information for the member specified with the member information with respect to the transaction target specified with the identification information received by the identification information reception unit and extracting the privilege information for the member received.

17. The non-transitory computer program product according to claim 15, further comprising:
outputting information required by a user for receiving a privilege as the privilege information.

18. The non-transitory computer program product according to claim 15, further comprising:
storing the identification information and price information of the transaction target specified with the identification information in a correlating manner.

19. The non-transitory computer program product according to claim 15,
wherein the identification information comprises a merchandise code.

20. The non-transitory computer program product according to claim 15,
wherein the privilege information comprises a coupon for a price reduction of the transaction target or a gift of additional reward points for purchasing the transaction target.
